(19) United States
(12) Patent Application Publication
(10) Pub. No.: US 2018/0257773 A1
(43) Pub. Date: Sep. 13, 2018

(54) System for Tethered Airboarding

(71) Applicant: Aaron Wypyszynski, Meridianville, AL (US)

(72) Inventor: Aaron Wypyszynski, Meridianville, AL (US)

(21) Appl. No.: 15/917,311

(22) Filed: Mar. 9, 2018

Related U.S. Application Data
(60) Provisional application No. 62/469,627, filed on Mar. 10, 2017.

(51) Int. Cl. B64C 31/028; B64D 3/00; B64C 39/02

(52) U.S. Cl. CPC B64C 31/028; B64C 39/022; B64D 3/00

(57) ABSTRACT

A tethered airboarding system includes an a lifting board an attachment point for a tether line, and a wind generating device. An improved lifting board includes a universal binding connector comprising a removable panel reversibly secured to a receiving element and a binding attached to the removable panel for securely attaching an operator onto the lifting board.

### BACKGROUND OF THE INVENTION

### Field of the Invention

The present invention relates to devices and systems, referred to herein as airboards and airboarding systems, which can be used to ride on air.

### Discussion of Related Art

U.S. Pat. No. 3,295,792 describes a tow glider with a wing positioned above a rectangular load support and a tow connector for attachment to a tow cable. This configuration is essentially a four wheeled cart attached to a wing intended for carrying cargo. U.S. Pat. No. 3,352,275 describes an aquatic glider with a broad under surface and floats that can be towed over the surface of water by a boat until reaching a speed sufficient for glider to become airborne. The aqua glider is configured for a person to stand on the glider and glide behind a towing watercraft close to the water's surface. U.S. Pat. No. 4,898,345 describes a “skyboard” which combines a specially designed surfboard and a parachute that is intended to allow a rider to ride the air currents of the sky. The skyboard has the general shape of a surfboard and is modified to include pairs of front and rear wings on its lateral sides. The skyboard is configured for a rider to stand on the board and maneuver it with his feet as one would manoeuvre a surfboard to cause the fins on the underside of the skyboard to catch and channel the air flow and provide lift.

As commonly practiced, skydiving and wingsuit diving are necessarily experiences of relatively short duration limited by the vertical distance between the starting and ending points. Skydiving simulation facilities have been developed to achieve longer flight duration in enclosed, controlled environments providing a vertical windstream that mimics the experience of falling through the air. For example, U.S. Pat. No. 6,083,110 describes a vertical wind tunnel amusement device with a flight chamber in which a user may experience a simulated freefall through the atmosphere in relative safety. Fans above the flight chamber are connected through a duct provide airflow supporting the user in a vertical column of upwardly moving air. U.S. Pat. No. 7,156,744 describes a vertical wind tunnel flight simulator with many duct segments having diverging walls to reduce the height required for the flight simulator. These types of facilities are limited to vertical airflow and not used suitable for simulating flight involving lifting components such as wings for horizontal or non-falling flight simulation.

U.S. 2015/0266573 A1 describes a system for airboarding behind an aircraft that allows a rider to perform stunts behind an aircraft. The system comprises a lifting board, a handle, a tow rope that connects to the lifting board and the handle, and safety features specific to flying at altitude. The '573 system provides a flying experience that may be more intense, expensive, or time consuming than is desired by some people. Flying a tow-behind flying board requires significant training and physical ability and requires a powered aircraft as well as acceptable weather conditions. The present invention overcomes these limitations with a system for tethered airboarding that does not require an aircraft and provides a wide variety of flying experiences in an environment that need not be limited by weather or extensive preparatory training and physical ability.

### BRIEF SUMMARY OF THE INVENTION

The present invention provides a rider (or operator or pilot) the unique experience of free flight on a flying board with a maneuverability similar to that of a wakeboard. Simulated free flight may be achieved by tethering the board to a wind generation device or to a fixed point in a natural wind stream. The invention provides for wind generation and tethering systems, including closed-circuit wind tunnels, open-circuit wind tunnels, and fan assemblies specifically for tethered wing board flight. When conducting simulated flight operations, a source of wind stream is provided allowing the rider to experience flight speeds while remain fixed relative to the ground.

The Invention also provides improvements to known lifting boards and airboarding systems that allow a rider to be towed behind a vehicle in a position that allows the rider maneuverability of the craft by means of body position and weight shift.

### BRIEF DESCRIPTION OF THE DRAWINGS

The elements of the drawings are not necessarily to scale relative to each other, with emphasis placed instead upon clearly illustrating the principles of the disclosure. Like reference numerals designate corresponding parts throughout the several views of the drawings in which:

FIG. 1 is a perspective view of a first embodiment of a wing board;

FIG. 2 is a detailed perspective view of a first embodiment of a control bar;

FIGS. 3a-c provide perspective views of shock absorbing structures and landing gear;

FIGS. 4a,b are views of first and second embodiments of control bar configurations;

FIGS. 5a-c are perspective views of three embodiments of a wingboard having different rider configurations;

FIGS. 6a-e are perspective views of five embodiments of a wingboard having different board configurations;

FIGS. 7a-f illustrate different tow line or anchor line geometries;

FIG. 8 is a perspective showing one embodiment of a safety tether system configuration; and

FIGS. 9a-c are views of exemplary configurations for dual board systems.

FIGS. 10a-d are views of exemplary configurations of the universal binding connector

FIG. 11 is a view of exemplary configurations of different rider attachments for a universal binding.

### DETAILED DESCRIPTION OF THE INVENTION

The term “tow line” is used herein to refer to tow line and also as a generic term encompassing a tow line and a tether line. “Tow line” when used in the context of a tethered system is understood to refer to a tether line since towing is not involved in a tethered system.

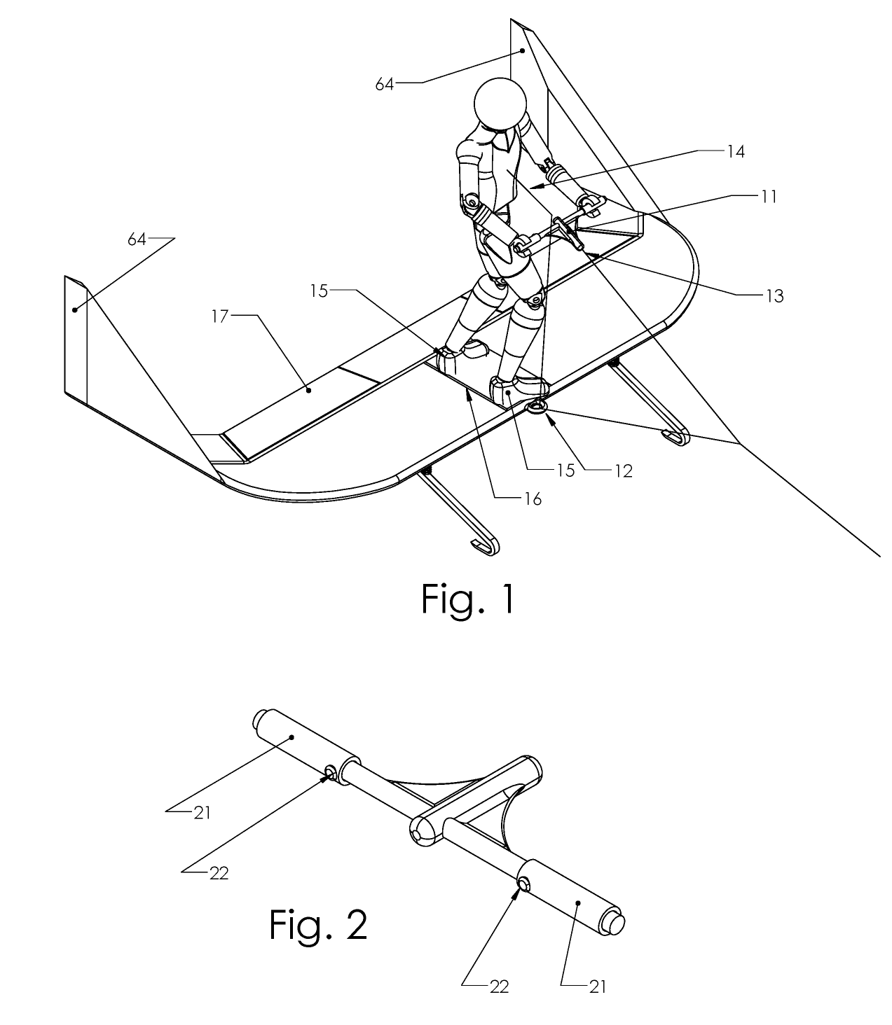

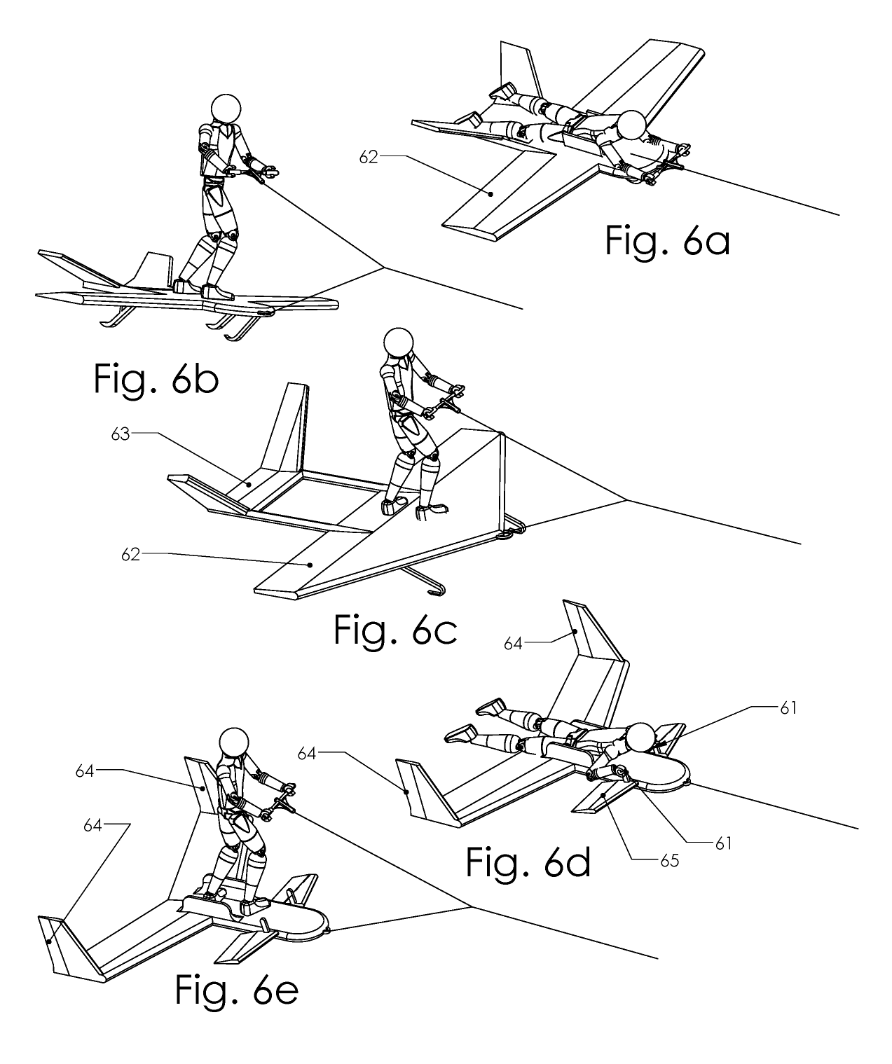

FIG. 1 shown a winged lifting board that is configured to provide lift to support the rider. The embodiment shown in FIG. 1 comprises a single tailless wing. To provide a variety of experiences, other embodiments of the lifting board may comprise alternative configurations of aerodynamic surfaces that may comprise features such as additional wings and/or tails, as shown in FIGS. 6a-e. The board configurations shown are not intended to be exhaustive but serve to illustrate a number of variations of board configurations among those that are possible. The embodiments of the lifting board shown are suitable for use in tethered flight as well as towed flight, wherein an embodiment having landing gear comprising one or more wheels being better suited for tow behind flight than an embodiment without wheels.

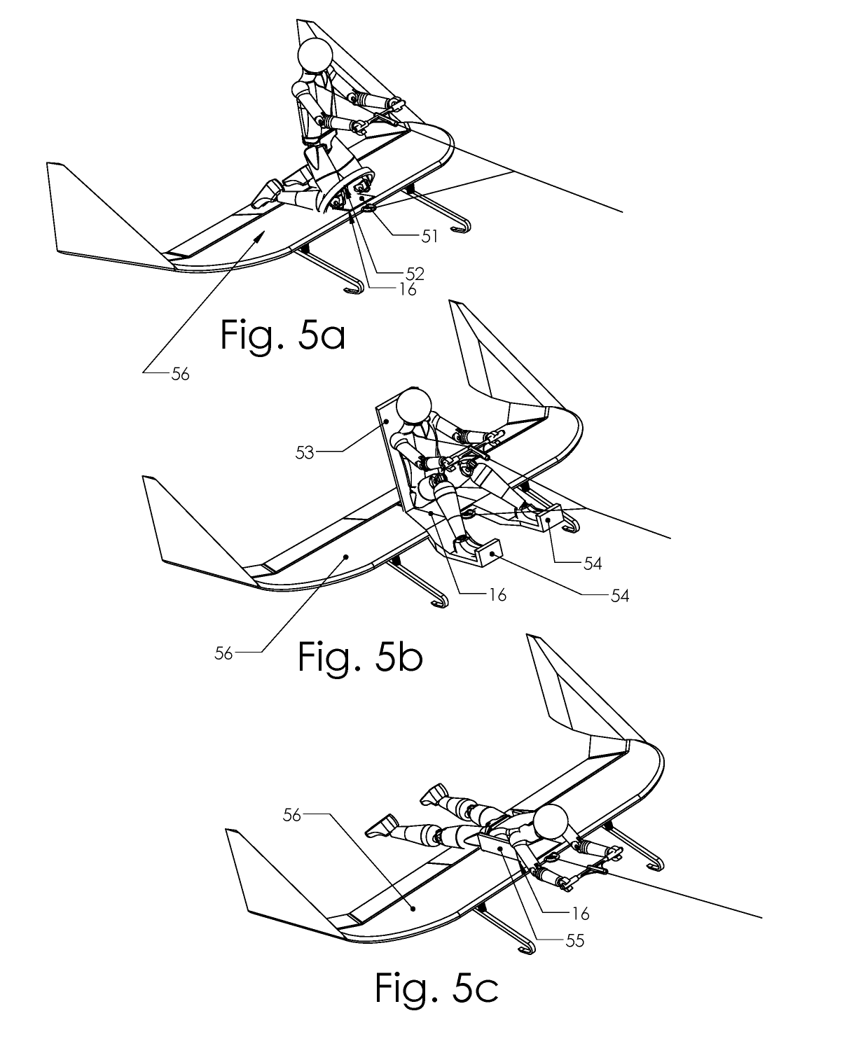

The lifting board comprises a universal binding connector (16) that may be used to affix different rider attachments with different configurations allowing different rider attitudes for any given board configuration. This allows the same lifting board to be used for a variety of rider attachment configurations, and makes such attachment configurations easily interchangeable. As shown in FIGS. 1 and 5a-c, such rider attachment configurations may be configured specifically to allow the rider to stand, sit, kneel, or lay on top of the board in a prone position.

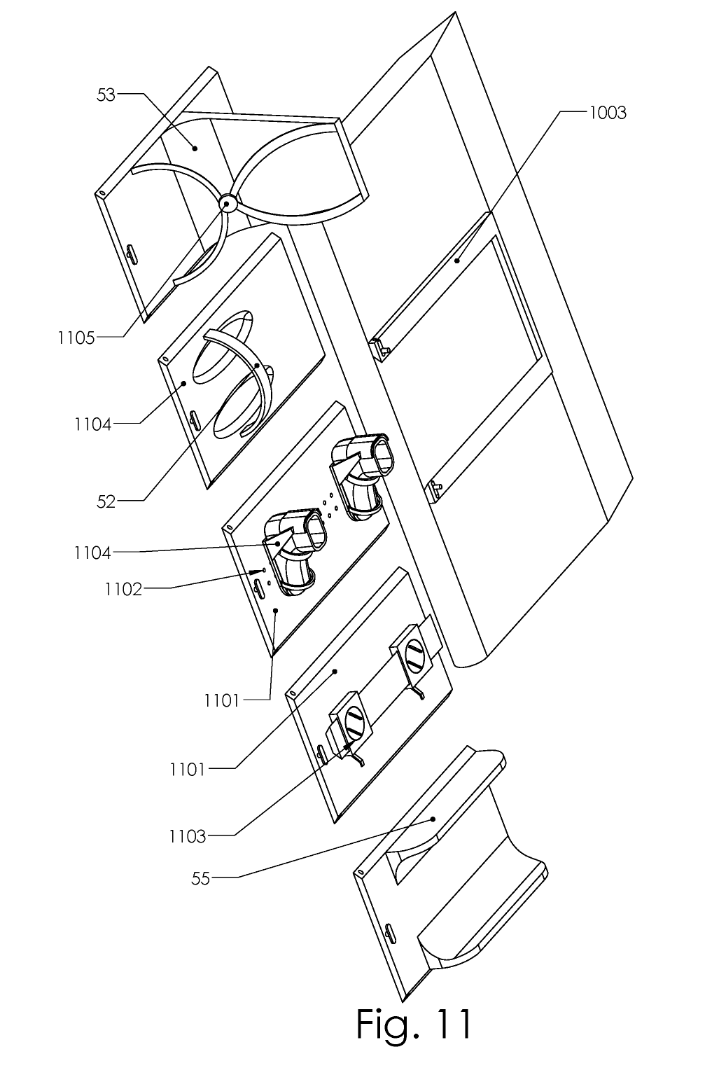

The rider may be affixed to the board via a means appropriate to the individual board specifications as determined, for example, by both board configuration and rider attachment configuration. Several examples are depicted in FIG. 11. For instance, in the standing configuration (FIG. 1), the rider may be mounted to the board via a universal binding connector (16) comprising a removable panel (1101) with two foot bindings (15) that secure the rider to the board via his or her feet. The foot bindings (15) may be similar to those used with ski boots or snowboard boots or similarly functioning bindings known in the art that allow swift fitting and adjustment to meet an individual rider's needs. Securing the foot bindings (15) to the removable panel (1101) may be accomplished in a number of ways, including screws and/or bolts (1102), or similar means that lock the rider's boots into the desired position on a removable panel (1101) of the universal binding connector (16). Additionally or alternatively, a system of channels and corresponding hardware (1103) within the removable panel (1101) may be used to lock the rider's boots into desired positions. The removable panel (1101,1104) may be secured to a receiving element (1002) on the board via securing means such as bolts (1001), cam locks (1004), clips (1005), an under board pin locking mechanism (1006), an adjustable channel system comprising channels and corresponding hardware (1103) and/or other quick-release fasteners. The locking mechanisms may be operated by passive, manual, spring loaded, electrical, or by other automated means. Bindings for each flying position may be fitted and adjusted in advance of flight, and their settings may be maintained until use. Securing means (1001) connecting the removable panel (1101) to the receiving element (1002) enable the rider to swiftly attach to the board with minimal or no additional adjustment, and swiftly release from the board. The removable panel with foot bindings (1104) may additionally or alternatively employ wakeboard-style bindings in which the rider's feet are secured by flexible restraints already attached to the bindings (15), which may also be adjusted to fit an individual rider's needs before flight. The foot bindings (15) and other types of bindings may be designed to release from the removable panel (1101) when a force in excess of a predetermined force is exerted by, for example, one or both foot bindings (15) on foot binding attachments (1104) on the removable panel (1101). For example, a foot binding may be released from the lifting board in response to one or more of a twisting force, a forward force, a lateral force, and a backward force above a set threshold. Additionally or alternatively, the removable panel (1101) may be designed to release from the receiving element (1002) when a force in excess of a predetermined force is exerted by the removable panel (1101) on the receiving element (1002). This may be preferred for seated, and prone flying positions, for example.

FIG. 5a illustrates an example of a lifting board configured for flying in a kneeling position. The rider may be affixed to the lifting board (56) using a method adopted from kneeboards and other similar devices in the art, which connect to a removable panel of a universal binding connector (16). The removable panel configured for the kneeling position (51,1104) may be flat or molded and is used to secure the lower legs of a rider in position via a strapping mechanism (52) that restrains the riders' thigh and/or calf in position. To accommodate variations in rider skill level and/or for comfort, an optional posterior cushioning device may be placed between the heel/calf and the rider's posterior.

FIG. 5b illustrates an example of a lifting board (56) configured or flying in a seated position. This example comprises a seat (53), attached to a removable panel (1003) which, in turn, is secured to the lifting board (56) via receiving element (1002) of a universal binding connector (16). The seat (53) supports the rider's back and posterior, and a harness and/or seatbelt device (1105) restrains the rider in the seat (53), thereby affixing the rider to the board. Optional leg supports (54) may also be used to support and restrain the rider's lower legs and feet and/or to protect the rider in case of impact with the ground and/or to provide leverage for yaw control.

FIG. 5c illustrates an example of a lifting board (56) configured or flying in a prone position. This example comprises a hip saddle device (55) attached to the lifting board (56) via a universal binding connector (16). The saddle device (55) provides lateral support to the rider and prevents side-to-side slippage. The saddle device (55) also allows the rider to brace against longitudinal drag forces. The saddle device may comprise a strapping mechanism and/or a harness device (1105) to secure the rider in position in the saddle device (55). A support may be placed between the rider's legs to aid in keeping the rider from sliding backwards on the lifting board (56).

All embodiments of the lifting board, regardless of board configuration, are scalable to meet the needs of a particular rider's size, physique, and/or ability level. Additionally, the size, shape, and configuration of the lifting board may optimized for different flight regimes and maneuverability. For example, smaller lifting boards may be used for higher speed flight or smaller riders. Larger lifting boards may be employed for heavier riders or slower flight. The board shape and configuration may also be modified to allow for different levels of maneuverability, with larger, more stable lifting boards being better suited for use by novices and smaller, less stable lifting boards being better suited for use by advanced riders.

A system for flying the lifting board behind a towing aircraft or flying the lifting board while tethered in a stream of moving air comprises a control bar (11), an example of which is shown in FIG. 2. During flight in either environment, the rider holds the control bar (11), which may be used to directly manipulate control surfaces located in various positions on the board via control grips (61) that actuate one or more control surfaces, for example by mechanical cables or by wired or wireless (fly-by-wire) communication with actuators attached to the control surfaces. Whether or not the control bar (11) is used to manipulate control surfaces and the locations and types of control surfaces manipulated depends on the particular lifting board wing configuration as well as the rider attachment configuration. Exemplary control surfaces include, but are not limited to, ailerons (62), elevators (63), rudders (64), elevons (17), canards (65), and lift augmentation devices such as flaps.

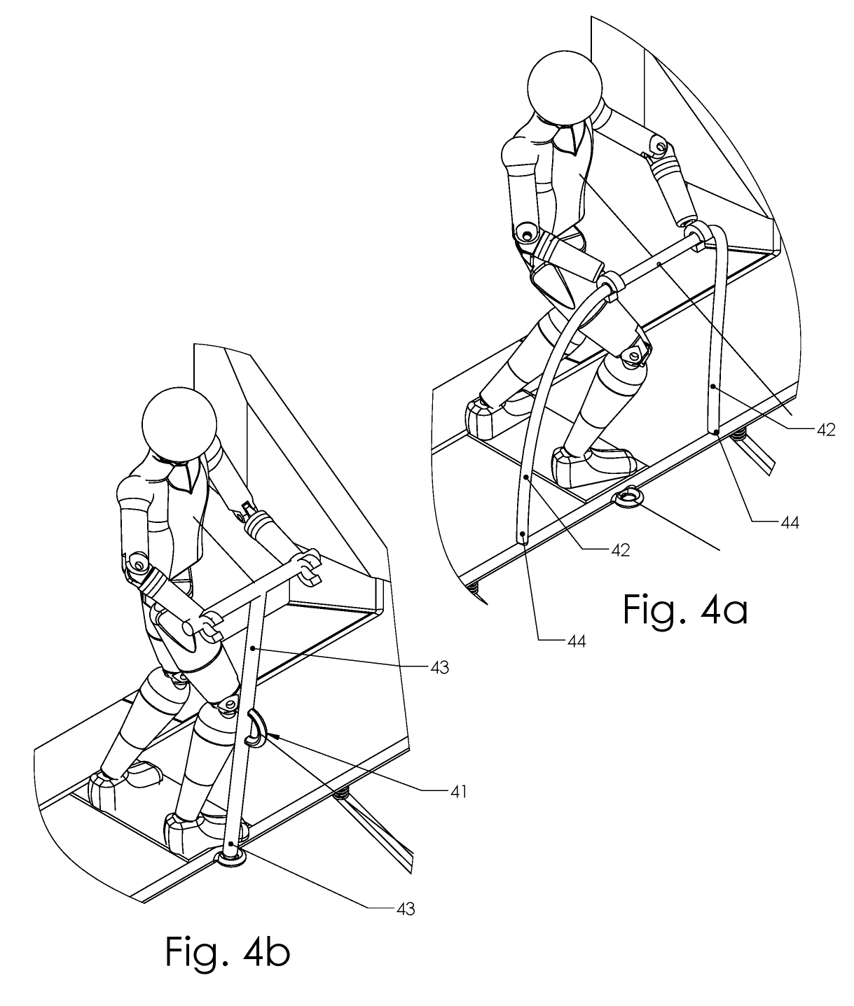

FIGS. 4a,b show two examples of a lifting board comprising a control bar (11) connected to the lifting board by a support bar (42,43). The control bar (11) may be grasped by the rider, providing a standing rider with more support. than a control bar (11) not attached to the lifting board. The support bar may comprise a straight, curved, bent, or angled rod (42). The support bar may form a T-shape (43) and form all or a part of the control bar (11). The support bar (42,43) may be rigidly, pivotally, or flexibly connected to the lifting board at one or more attachment points (44). The support bar (42,43) may comprise a tow or tether line attachment point (41) so that the support bar may be used to tow or tether the lifting board. In such embodiments of the lifting board, the support bar (42,43) is attached to the lifting board at attachment point(s) (44) either rigidly or flexibly. The examples of control bar (11) and support bar (42,43) configurations are not meant to be exhaustive and many alterations to and variations in their configurations are possible and can be tailored to meet the needs of different rider attachment configurations and rider positions.

A method for flying a lifting board according to the invention involves controlling flight through the shifting of body weight and changing the position of the body on the lifting board. A primary means of controlling flight is by body position. For instance, the rider may lean left or right for roll control and rotate the upper torso left or right for yaw control. The rider may also change the pitch angle of the board by a combination of leaning forward and/or backward and pulling in and/or extending out his or her arms and gripping the control bar. For additional control or to accommodate riders with physical limitations, control actuation may be employed in addition to or as an alternative to certain body movements. The controls may be manipulated by force and/or rotation sensors mounted on the body or in the board. One such example is a force/load sensor mounted in a binding that senses the side-to-side lean of the rider and actuates roll control devices. Control input may also be employed by the rider by means of control input device or devices such as sensors or buttons on the control bar. One such method for roll input may be by means of rotational grips on the control bar (21) that actuate the control surfaces (FIG. 2). A second embodiment of the control input may be by means of button(s), toggles, and/or joystick(s) (22).

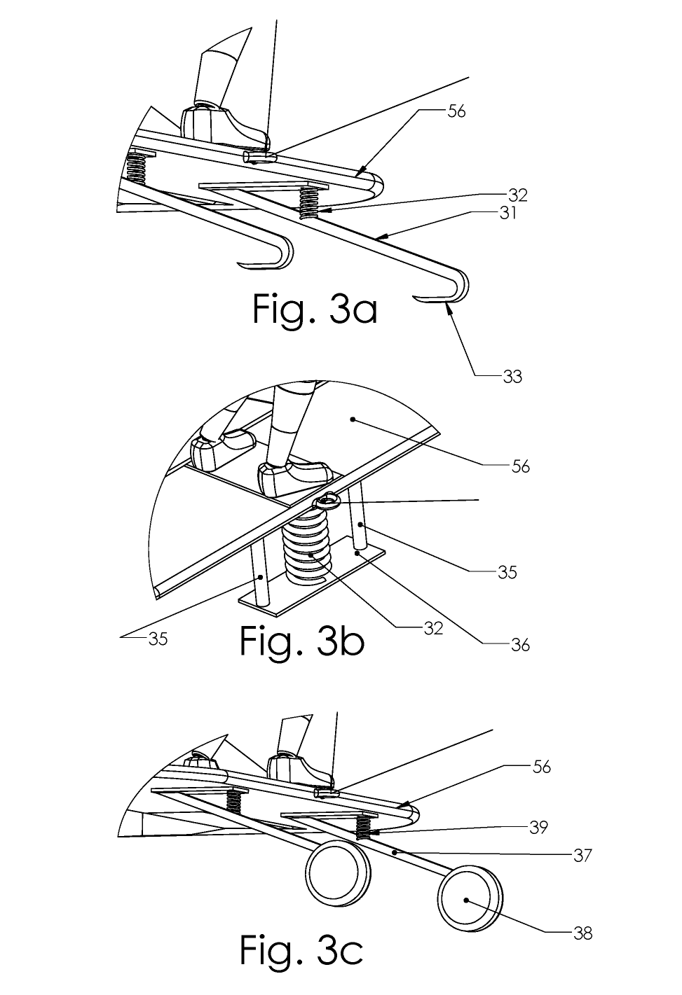

The lifting board may be used for flight behind a towing aircraft or for flight while tethered in a stream of moving air similar to that produced by a wind tunnel. For flight behind a towing aircraft, the lifting board preferably comprises landing gear (37) with wheels (38) as shown in FIG. 3c. Additionally or alternatively, shock-absorbing structures (32) may be positioned on the lower surface of the lifting board as shown in FIGS. 3a,b. Shock absorbing structures may comprise a lever (31) with compressive spring, elastomer, cushion, and/or air cushion (32) placed between the lever (31) and the bottom of the lifting board (56). The end of the lever extending downward and away from under the lifting board may terminate in a skid or wheel (33), for example, as shown in FIG. 3a. This configuration may also aid in preventing tip-over of the board. Shock-absorbing structures may comprise a spring, elastomer, cushion, and/or an air cushion (32) and compressible struts and/or other support structures (35). In addition to providing a surface on which to land, these structures aid in positioning the board at a specific angle, thus enabling easier takeoffs and landings, as well as absorbing the shock of any impact with the ground. Additionally, the tail and/or the wingtips may, when combined with the flexibility of the board structure, act as an additional shock-absorbing structure. Shock absorbing structures may be particularly useful for tethered flight because the lifting board remains in close proximity to the ground in which contacts with the ground during flight may be possible.

A number of passive and active means may be used to provide stable flight for the rider of a lifting board when towed or tethered. Passive means, include the aerodynamic design of the board, which provides the primary means of stabilizing flight. The lifting board may be designed such that it remains pointed into the wind on a stable flight path, even in the absence of input by the rider. The aerodynamics also take into account the forces imparted on the board by the main tow line or tether line in order to eliminate any unstable oscillations caused by interactions between the tow line interactions and the lifting board. Tow line geometry may contribute to flight stability or instability depending on the method by which the main tow line(s) are attached to the lifting board and/or the rider. The kinematics of the tow line-board-rider system determine one or more tow line attachment points that automatically stabilize the lifting board as well as limit the lifting board's ability to reach unstable flight regimes. These attachment points can be adjusted based on rider size and ability level to achieve the desired level of stability, limit the pitch angle of the board, and/or keep the board within a desired flight envelope.

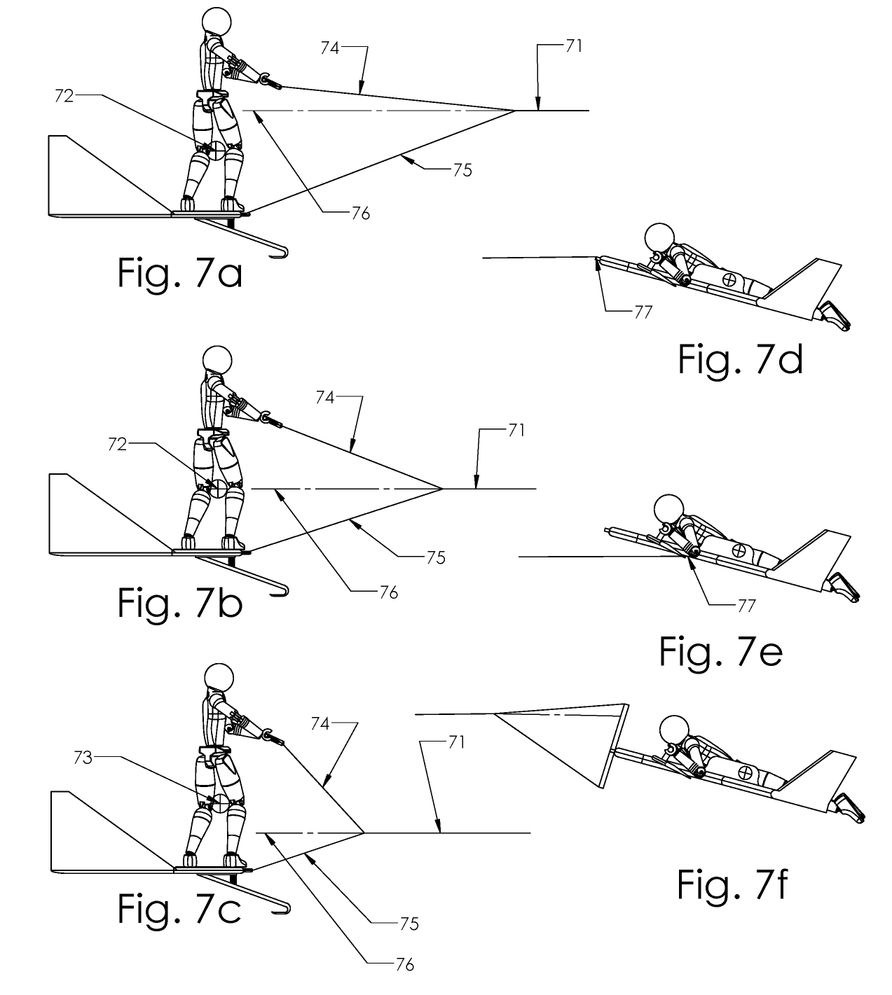

The main tow line (71) may comprise a split-rope towline system. For example, a Y-shaped attachment system may be used, wherein the top (74) and bottom (75) rope lengths are varied to adjust the effective tow or tether force location (76) relative to the rider-board system center of mass (73) and center of drag (72). Shortening the top line going to the rider results in more force being placed on the top line and thus the effective center of tow/tether force being higher on the system. By lengthening the top line, more force is placed on the tow line going to the board, effectively lowering the location upon which the tow forces are exerted on the system. By placing the effective tow location high above the drag center (72), the drag forces force the system to tend toward pitching down, resulting in stable pitch flight (FIG. 7a). As the effective tow point approaches the system drag center, the board becomes more sensitive in pitch (FIG. 7b). Additionally, roll stability is greatly affected by the placement of the effective tow center in relation to the system center of mass. When the tow point is located above the system center of mass (73), the tow line forces help to stabilize the roll by rolling the wing toward the center and providing a self-correcting force. When the effective tow location is placed below the center of mass, the tow/tether line forces result in the board rolling away from center, creating a destabilizing force, increasing maneuverability (FIG. 7c). The Y-tow line configuration also aids to limit the pitch angle of the board. As the system pitches up, the force on the bottom tow line is decreased and the force on the top tow line is increased. A resulting nose down pitching moment is induced as the top tow line rotates the rider forward, decreasing the pitch of the board in an attempt to balance the forces on the system. By adjusting the lengths on the top and bottom tow lines, the size of the pitch window may be adjusted. Using long tow lines results in a smaller pitch window, while using shorter tow lines results in a larger pitch window.

For embodiments having a single tow line attached to the lifting board, such as those shown in FIGS. 7de, the tow line location in relation to the front and the back of the lifting board may be used to set pitch and yaw stability. The further forward of the center of gravity the tow point (77) is located, the more stable the system becomes in both roll and pitch. To allow for a Y towline when the rider has little vertical height, such as when laying or sitting, a bar may be added that allows the towrope to be attached at both high and low locations as shown in FIG. 7f. This bar may be either fixed to the lifting board or be able to pivot with or independently of other control inputs. In a standing or kneeling configuration, a single attachment point may be used if that attachment point is connected to the control bar (43), which serves as the connection between the tow line, the lifting board, and the rider. To adjust the stability imparted by the tow line, the tow point (41) maybe moved up or down as determined by rider size, weight, and/or skill.

In addition to providing self-stabilization with no rider input, the tow/tether line configurations can minimize external forces acting on the rider, thus easing the physical burdens on the rider and enabling riders to relax into a more natural position for any given rider attachment configuration. FIG. 1 depicts one embodiment of a twin attachment point for a rider in a standing position wherein the first tow line attachment (12) is on the board while the second tow line attachment (13) is at the control bar (11) held by the rider. An additional attachment (14) may connect the control bar (11) to a harness, similar to a climbing, fall protection, or parachute harness, worn by the rider to relieve the forces on the rider's arms and upper body.

Active stability may be provided to enable easier control as well as help ensure stable flight, particularly for novice riders. Stability may be computer controlled to maintain specific flight angles and rotation rates based on input from the rider and/or external observer(s). Control inputs may be provided by devices such as gyros, flow control devices, and control surfaces. For embodiments tethered within a stream of air, the controls may be used to limit the flight movements of the lifting board to a specific volume. Particularly, when flown within a facility with a limited windstream, the active controls may restrict the left/right and/or up/down extents of the flight area, keeping the rider within the wind stream. For the embodiment shown in FIG. 1, for example, ailerons (17) are located one on each side of the trailing edge of the board. The ailerons (17) may be used to provide roll control. A flight computer coupled to sensors and the controls may be used to maintain the rider in an upright position. Inputs from the rider may then be read by the flight computer and the ailerons may be actuated to maintain a specified roll angle or rate. These active stability devices may also be used to increase the maneuverability of the board. Pitch and yaw may be controlled via control surfaces such as elevators (63) and rudders (64) and/or other aerodynamic control surfaces.

The lifting board may be used for and/or adapted for flight within and/or around a wind-generating device such as a wind tunnel or fan that produces wind having primarily a horizontal component. A system comprising a lifting board and wind generating device may comprise one or more tethering locations to which the main towline (tether line) may be affixed. For instance, a fixed main tow line may be mounted to the wind generating facility or the ground and/or floor of the structure. Where an adjustable main tow line is required, adjustability may be achieved using any of a number of methods, including a single rope or a fixed structure that has an attachment point that can be moved vertically via motor and/or pulley system; multiple adjustable ropes under tension that allow the attachment point to be moved vertically and/or horizontally; and/or a gantry system that moves a support vertically and/or horizontally across a wind tunnel, whereby a track moves a carriage along one axis while the attachment point may be moved along another axis. This list is not all-inclusive, as any means of tethering may be employed as required. If a wind generating means mounted to a vehicle is used to provide the airflow required for flight, the lifting board may be tethered to the vehicle directly or to structures attached to or projecting from the vehicle.

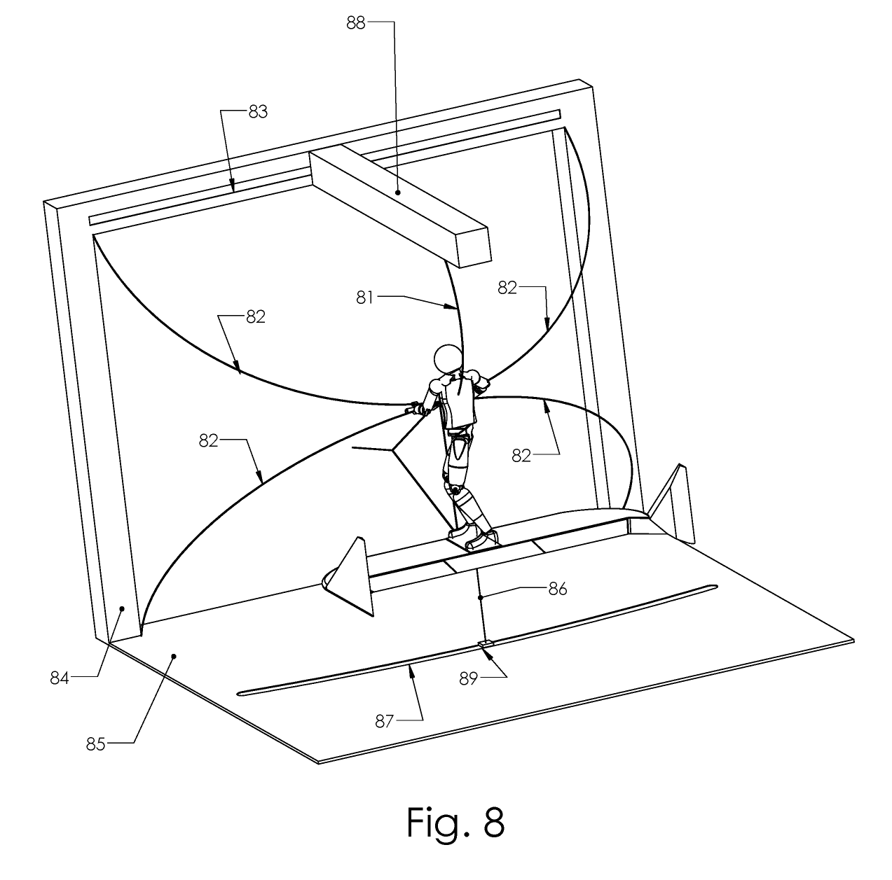

When conducting flight in a wind-generation device, various safety mechanisms may be used to maintain the rider within the wind stream and permit facility and/or equipment operator(s) to restrain board motion for training purposes, to provide additional stability, and/or to prevent injury in the event that the rider loses control. The safety features may comprise a series of safety harness lines, for example, as shown in FIG. 8. A primary safety harness tether (81) to provide fall protection connects to an attachment located on the rider's harness, for instance, on the back as shown in FIG. 8. The primary safety harness tether (81) may tether the rider to any of a number of surfaces, including a ceiling or wall of the surrounding building, structure, or a vehicle. Secondary safety tethers (82) may be used to provide support via secondary tether connection points. The number and locations of secondary safety tethers (82) and secondary safety tether connection points may be varied according to need. FIG. 8 shows and example comprising four diagonal secondary safety tethers (82). Another possible configuration may comprise two horizontal secondary safety tethers (82) and two vertical secondary safety tethers (82).

It is preferable that the safety tether configuration permit the rider free range of motion vertically and horizontally. This may be accomplished by using slack line(s) to provide rider freedom of motion that can be tensioned to restrict motion where and when required. One or more slack lines may be provided via an inertial brake reel, whereby fast acceleration causes the brake to lock and prevent the rider from falling. This system may be automated to maintain a minimum amount of slack during flight. A facility and/or equipment operator and/or observer may use the primary safety harness line(s) to pull the rider out of the wind stream vertically as needed or desired. Where an adjustable and/or moveable tether is required or desired, adjustability may be achieved any of a number of methods, including a single rope or a fixed structure that has an attachment point that can be moved, for example using a passive track system (83), whereby a track moves the carriage (88) along one axis (A1) while the attachment point may be moved along the other axis (A2). A relatively small amount of tension on the line permits the safety tethers to move and track the rider's movements. For more advanced configurations, a motorized system may move the attachment points in coordination with the location of the board and rider. Slack may be allowed on the tethers at all times to maintain free flight until actuated. The tethered lifting board flight system may comprise individual attachments that are moved independently or may be fixed to a moving frame (84) and/or platform (85) that follows the rider, maintaining the attachments in fixed geometry to each other but mobile relative to the facility.

The tethered lifting board flight system may comprise a bottom safety tether (86), which may be connected to the board to limit its upward vertical movement. The bottom tether's primary configuration may be a slack line that is loose to provide the rider free range of motion until a pre-defined height from the ground or floor is reached, at which point the tether goes taut and provides a small nose-down pitch correction to maintain the rider within the wind stream. In case of emergency, this tether can be used to pull the board immediately to the ground and fix it in place to prevent further flight. The bottom safety tether (86) may be attached to the ground or floor of the structure and/or facility. Where an adjustable and/or moveable tether is required or desired to permit additional maneuverability and/or to allow for more rapid engagement, adjustability may be achieved, for example, by including a single rope or a fixed structure that has an attachment point that can be moved, for example, via a passive track system whereby a track (87) moves the carriage (89). In such a case, a small amount of tension on the line permits the safety tethers to move and track the rider's movements. For more advanced configurations, a motorized system moves the attachment points in coordination with the location of the board and rider. Slack may be allowed on the tethers at all times, unless actuated, to maintain free flight. The system may comprise individual attachments that are moved independently and/or attachments fixed to a moving frame or platform that follows the rider and maintains the attachments in fixed geometry relative to each other but mobile relative to the facility.

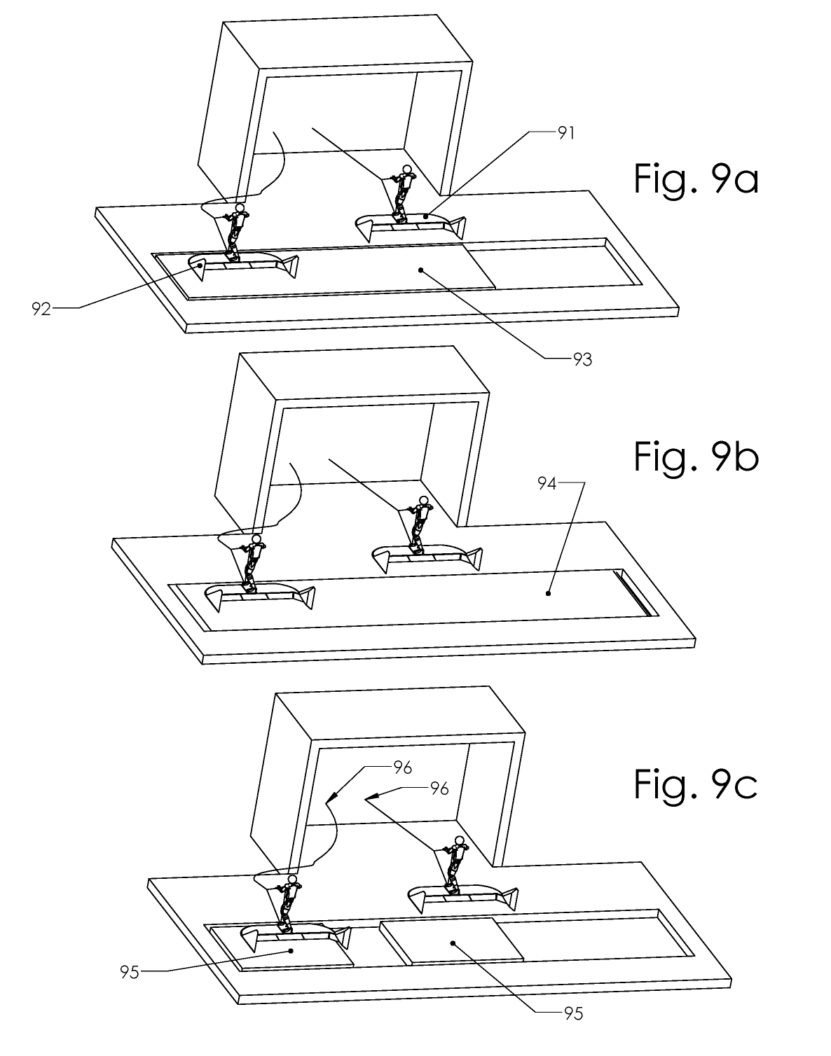

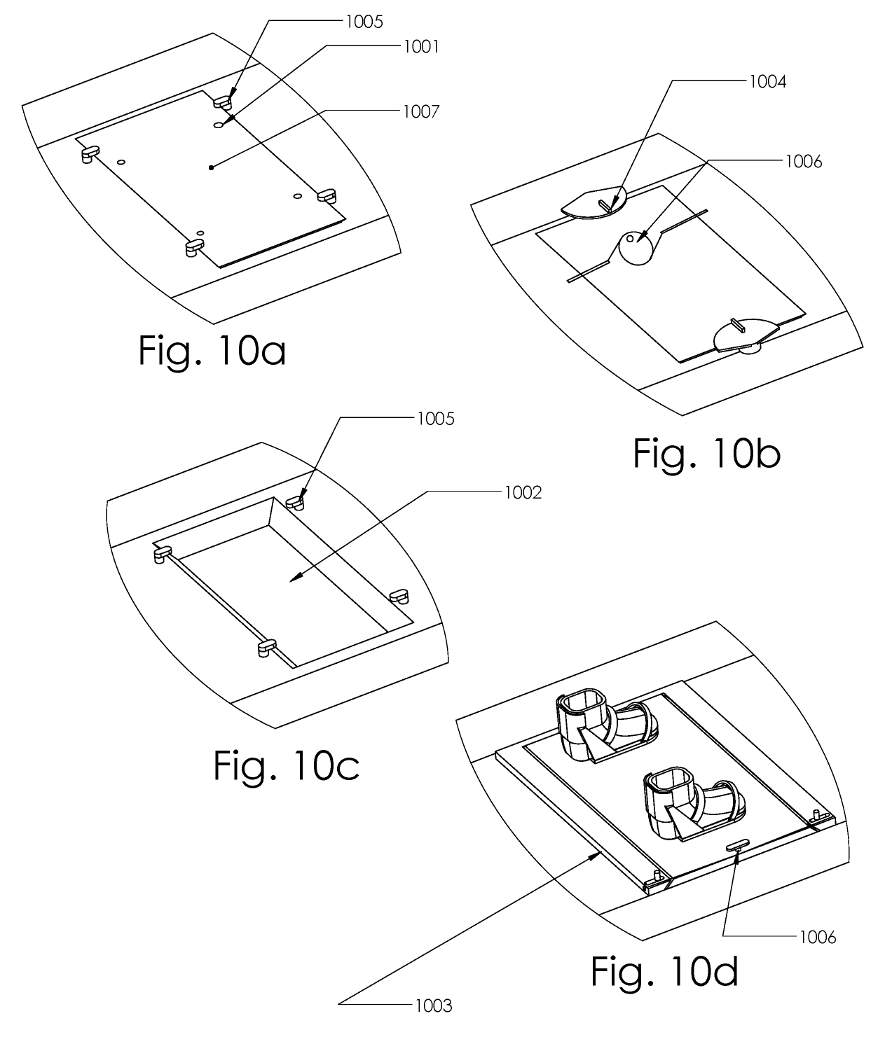

The main tow line attachment system may be configured to accommodate a dual-board system (FIG. 9a-c), in which dual attachment points may be configured to allow for multiple boards. In one embodiment, a dual-board system may be used to facilitate ease and rapidity of transition from one rider to the next wherein, at any given time, one lifting board may be in use to conduct operations within the wind stream (91) while the other lifting board remains outside the wind stream (92), e.g. while it is being readied for flight. The boards may be moved into and out of the wind stream manually by ground support personnel. Additionally or alternatively, a sliding floor system (93) or conveyor-belt system (94) may be used to move lifting boards into and out of the wind stream. The system may be either coupled such that one slider (93) or conveyor (94) simultaneously moves both boards, or the system may be configured with an independent moving system for each lifting board. The system may be manually operated or electronically automated. Dual main towline attachment points (96) allow both boards to remain tethered at all times, as one towline may be moved to the side while the other is in use. A dual-board system with dual attachment points may be configured to allow for multiple boards to be flown simultaneously, either in a side-by-side or staggered configuration.

To further enhance an in-flight environment or otherwise enrich the rider experience, a tethered flight system according to the invention may comprise Virtual Reality (VR) and/or Augmented Reality (AR) devices. For example, the rider may wear a helmet or similar device containing the virtual and/or augmented reality technologies to receive audio and/or visual inputs. Visual inputs may also be projected onto the surfaces of the wind tunnel or surrounding structure. In addition to simulating real-flight conditions, such audio-visual inputs may also provide simple simulations or interactive arcade-type simulations, providing a game-like experience. The VR and/or AR devices may be wireless or tethered (wired). For wireless embodiments, the associated processing computer can be located remotely from the rider and/or lifting board. Visualization can be transmitted wirelessly to a system worn by the rider, or integrated into a helmet or similar device. For tethered embodiments, a tether feeds the audio-visual inputs from an independent processor to the rider via a single wire or network of wires. For onboard embodiments, the computing system may be maintained either in the lifting board or as part of the VR and/or AR display with inputs from an associated onboard computer relayed either wirelessly or via a wire or network of wires. The position of the lifting board and/or rider may be tracked by integrated sensor technology to allow the VR and/or AR visuals to match the rider's actual position within the facility.

To allow the rider to effectively communicate in real-time with instructors, facility and/or equipment operators, and/or other persons in or around the facility or vehicle, in-helmet and/or in-suit communications devices and/or systems may be used. Such communication devices and/or systems may include, but are not limited to, microphones, headsets for verbal communication, cameras, and/or displays. Helmet mounted cameras may feed images to facility/equipment operators/observers. Displays visible to the rider, operators, and/or observers may show wind tunnel dashboard information to relay statistics useful to the rider and/or biometrics such as rider heart rate, temperature, and/or respiration rate. Power and transmission equipment may be packaged within the devices themselves or may be packaged onboard the board and connected and/or made available to the rider via a wire or network of wires.

Many variations and modifications may be made to the exemplary embodiments of lifting boards, towed and tethered flight systems, and methods described above without departing substantially from the spirit and principles of the disclosure. For example, wind for flying the lifting board may be provided by tethering the lifting board to a moving vehicle. Such a modification, however, introduces additional safety concerns and lacks advantages of a tethered system over a towed system.

1. A lifting board comprising:
a wing;
a universal binding connector comprising a removable panel reversibly secured to a receiving element
a binding attached to the removable panel for securely attaching an operator onto the lifting board, said binding being releasable from the lifting board in response to a force or a rotation speed; and.
a first attachment point for a tow or tether line.

2. The lifting board according to claim 1, further comprising landing gear comprising wheels.

3. The lifting board according to claim 1, further comprising landing gear comprising a shock absorber.

4. The lifting board according to claim 1, wherein said first tow or tether line attachment point is on a leading edge of the wing and the lifting board further comprises a second tow or tether line attachment point positioned to limit the pitch of the wing during flight.

5. The lifting board according to claim 1, further comprising a control bar attached to the lifting board.

6. The lifting board according to claim 5, wherein said first tow or tether line attachment point is on a leading edge of the wing and the lifting board further comprises a second tow or tether line attachment point on the control bar.

7. The lifting board according to claim 6, further comprising a parachute and wherein said force/load sensor is configured to automatically release a tow rope and/or said parachute in response to a sensed speed, a sensed rotation rate and/or an acceleration.

8. An airboarding system comprising:
a lifting board comprising
a wing,
a binding for securely attaching an operator onto the lifting board, said binding being releasable from the lifting board in response to a force or a rotation speed, and
a first attachment point for a tether line;
a wind generating device;
a tether line; and
a tethering location
wherein the tether line connects the lifting board to the tethering location through the first attachment point for a tether line.

9. The airboarding system of claim 8, further comprising a control bar comprising a second attachment point connected to a tether line.

10. The airboarding system of claim 9, wherein the tether line comprises a branching point so that the tether line has a Y-shape and the tether line is attached to the first and second attachment points and to the tethering location.

11. The airboarding system of claim 10, wherein the branch point is adjustable to change a length of a first branch of the tether line relative to a second branch of the tether line.

12. The airboarding system of claim 8, further comprising a harness to be worn by the rider and wherein said harness comprises a second attachment point for a tether line.

13. The airboarding system of claim 12, further comprising a second tethering location connected to the harness via said second attachment point.

14. The airboarding system of claim 13, wherein the second tethering location moves during lifting board flight.

15. The airboarding system of claim 8, comprising additional tether lines connecting the lifting board to additional tethering locations to limit the range of motion of the lifitng board.

16. The airboarding system of claim 15, wherein at least one of said additional tethering locations moves during lifting board flight.

17. The airboarding system of claim 8, wherein the tethering location moves during lifting board flight.

18. The airboarding system of claim 8, wherein the lifting board comprises a universal binding connector comprising a removable panel reversibly secured to a receiving element and the binding is attached to the removable panel.

19. The airboarding system of claim 18, wherein the receiving element and the removable panel are configured such that the removable panel releases from the receiving element when a force in excess of a predetermined force is exerted by the removable panel on the receiving element.
